(19) United States
(12) Patent Application Publication
(10) Pub. No.: US 2009/0158870 A1
(43) Pub. Date: Jun. 25, 2009

(54) Linear Actuator

(76) Inventor: Yung-Tsai CHUO, Taichung Industrial Park (TW)

Correspondence Address: Dr. BANGER SHIA, 102 Lindencrest Ct., Sugar Land, TX, 77479-5201, US

(21) Appl. No.: 11/961,994

(22) Filed: Dec. 20, 2007

(51) Int. Cl. F16H 29/02

(52) U.S. Cl. 74/89.34

(57) ABSTRACT

A linear actuator orderly comprises an inner pipe, a middle pipe and an outer pipe, and the pipes are pivotally connected with each other. Each pipe is formed with at least three arc-shaped portions and three guiding portions, and the pipes abut against each other. The outer pipe is axially formed with a screw and two positioning rods that are passed through the middle pipe and the inner pipe, respectively. One end of each positioning rod is fixed with a pulling member, and one end of each pulling member is fixed to the inner pipe. The middle pipe is axially formed with a pushing post threaded with the screw. The pushing post and the middle pipe are pivotally disposed with a guiding wheel for rolling the pulling members, respectively. The pipes can be moved by the relative motion of the screw and the pushing post by cooperating with the guiding wheels and the pulling members, such that the pipes can be extended or retracted synchronously.

### BACKGROUND OF THE INVENTION

1. Field of the Invention

The present invention relates to an actuator, and more particularly to a linear actuator.

2. Description of the Prior Art

The use of actuators is quite extensive, and one kind of the actuators is the nonsynchronous actuator. Referring to FIG. 1, a conventional nonsynchronous actuator 90 comprises a base 91, a first cylinder 92, a second cylinder 93, a third cylinder 94, a motor 95, a first screw 96, a second screw 97 and a third screw 98.

The first cylinder 92 includes a containing space 921, and one end of the first cylinder 92 is fixed to a top side of the base 91.

The second cylinder 93 includes a containing space 931 and is pivotally disposed in the containing space 921 of the first cylinder 92.

The third cylinder 94 includes a containing space 941 and is pivotally disposed in the containing space 931 of the second cylinder 93. The motor 95 is fixed to one end of the third cylinder 94.

The first screw 96 is a hollow member and is defined with outer threads 961, and one end of the first screw 96 is fixed to the top side of the base 91.

The second screw 97 is a hollow member and is defined with first inner threads 971 and second inner threads 972 that are threaded with the outer threads 961 of the first screw 96. One end of the second screw 97 is assembled to the opening end of the containing space 931 of the second cylinder 93, and the other end of the second screw 97 is assembled to the opening end of the containing space 941 of the third cylinder 94.

The third screw 98 is a hollow member and is defined with first outer threads 981 that are threaded with the first inner threads 971 of the second screw 97. And one end of the third screw 98 is dynamically connected to the motor 95.

Referring to FIG. 2, during the operation of the nonsynchronous actuator 90, the motor 95 rotates the third screw 98 and drives it to move along the second screw 97, so as to drive the third cylinder 94 to move. When the third screw 98 rotates to the maximum length position relative to the second screw 97 as shown in FIG. 3, the third screw 98 will be driven by the motor 95 to rotate the second screw 97, and the second screw 97 will move along the first screw 96 and drive the second cylinder 93 to move. However, the above-mentioned conventional nonsynchronous actuator still has the following disadvantages:

Firstly, the extending and retracting motion of the conventional nonsynchronous actuator takes a lot of time, since the second cylinder 93 can be driven to move only when the third cylinder 94 moves to the end of maximum travel length.

Secondly, since the second screw 97 can be driven to rotate only when the third screw 98 rotates to the end of maximum travel length, the first cylinder 92, the second cylinder 93 and the third cylinder 94 are likely to be rotated by the first screw 96, the second screw 97 and the third screw 98 due to the circular shape design, the linear motion of the cylinders will be influenced. As a result, the conventional nonsynchronous actuator is instable and is imprecise.

The present invention has arisen to mitigate and/or obviate the afore-described disadvantages.

### SUMMARY OF THE INVENTION

The primary objective of the present invention is to provide a linear actuator which can be extended or retracted synchronously by the relative motion of a screw and a pushing post by cooperating with a plurality of guiding wheels and pulling members, so as to reduce the extending and retracting time of the linear actuator.

The second objective of the present invention is to provide a linear actuator which can prevent the outer pipe, the middle pipe and the inner pipe from rotating by a plurality of arc-shaped portions and guiding portions, so as to improve the stability and precision of the linear motion of the linear actuator.

The third objective of the present invention is to provide a linear actuator which can control the tension of the first pulling member and the second pulling member by adjusting the height of two positioning rods by two adjustment screws.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of a conventional nonsynchronous actuator;

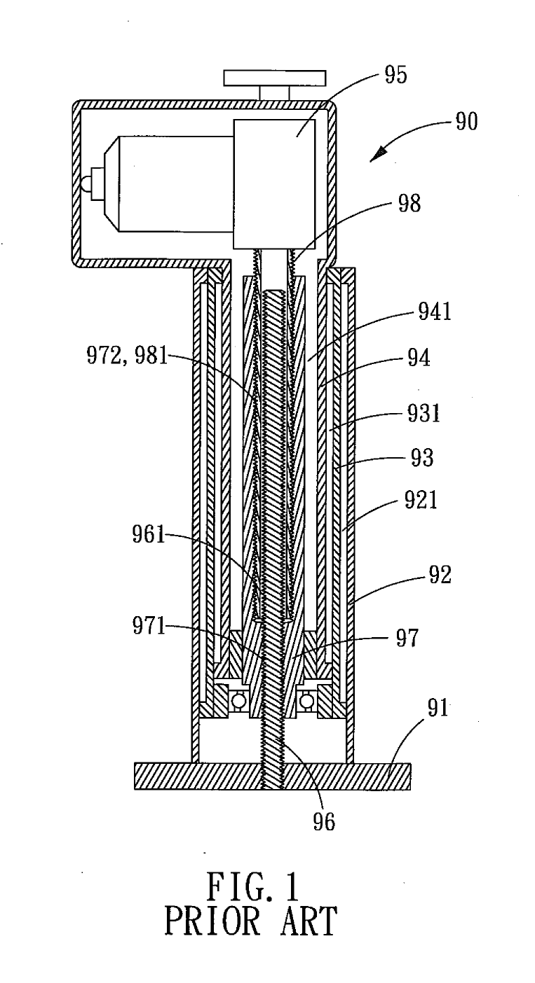

FIG. 2 is an illustrative view showing the extending motion of the conventional nonsynchronous actuator;

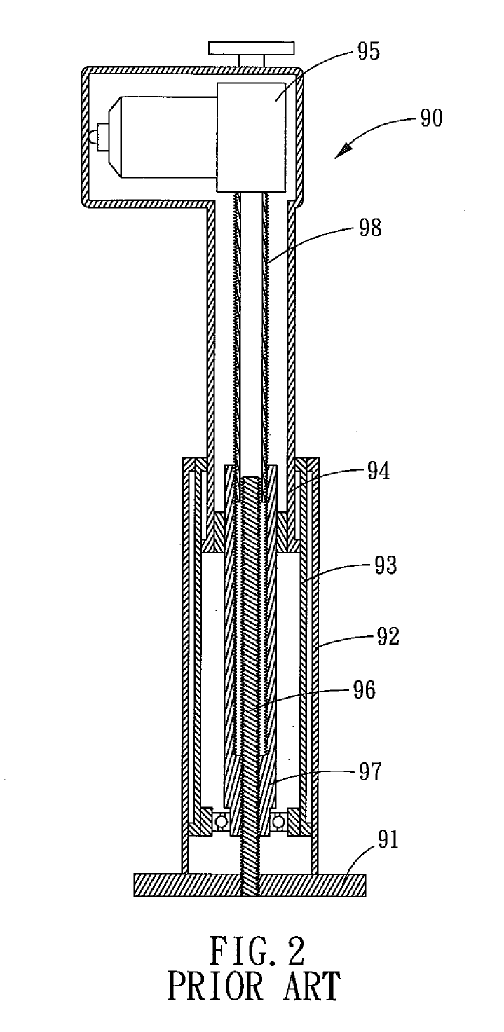

FIG. 3 is an illustrative view showing the extending motion of the conventional nonsynchronous actuator;

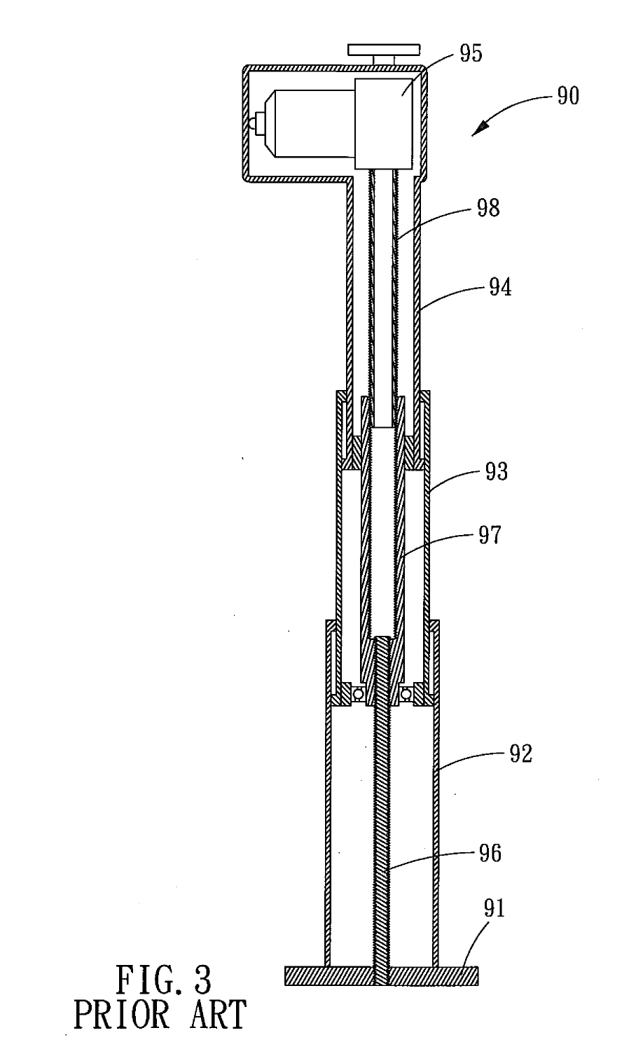

FIG. 4 is a perspective view of a linear actuator in accordance with the present invention;

FIG. 5 is an illustrative showing the linear actuator not being extended;

FIG. 6 is an illustrative showing the linear actuator not being extended;

FIG. 7 is an illustrative view showing the linear actuator being extended; and

FIG. 8 is an illustrative view showing the linear actuator being extended.

### DETAILED DESCRIPTION OF THE PREFERRED EMBODIMENTS

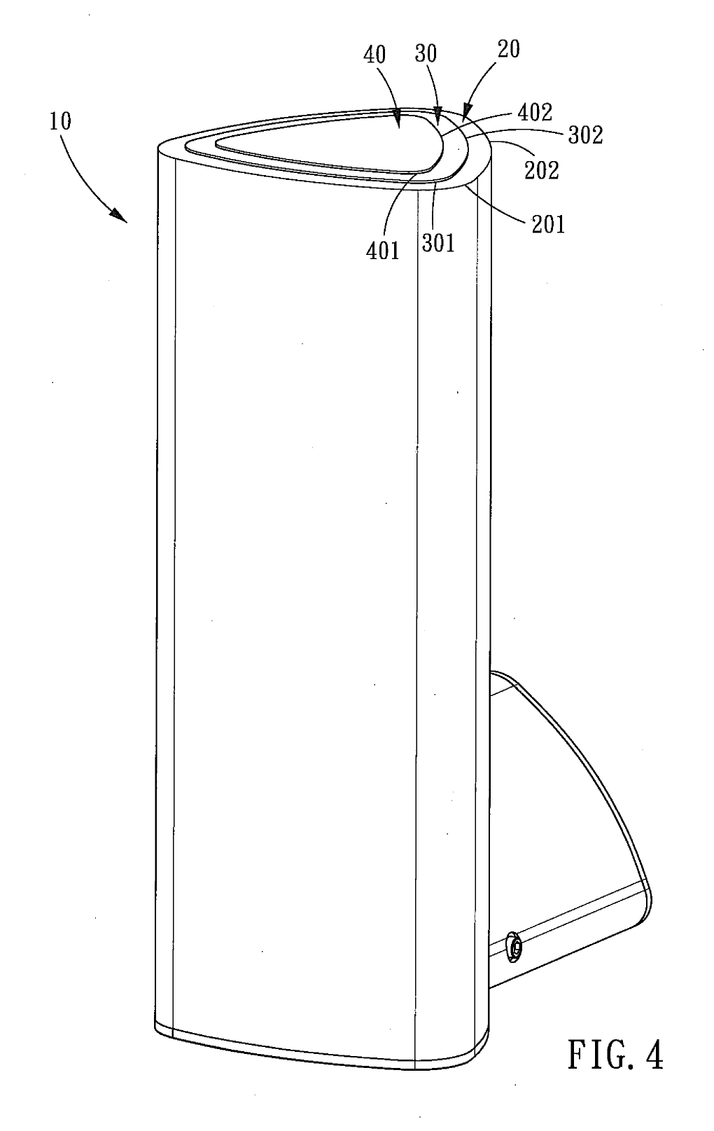

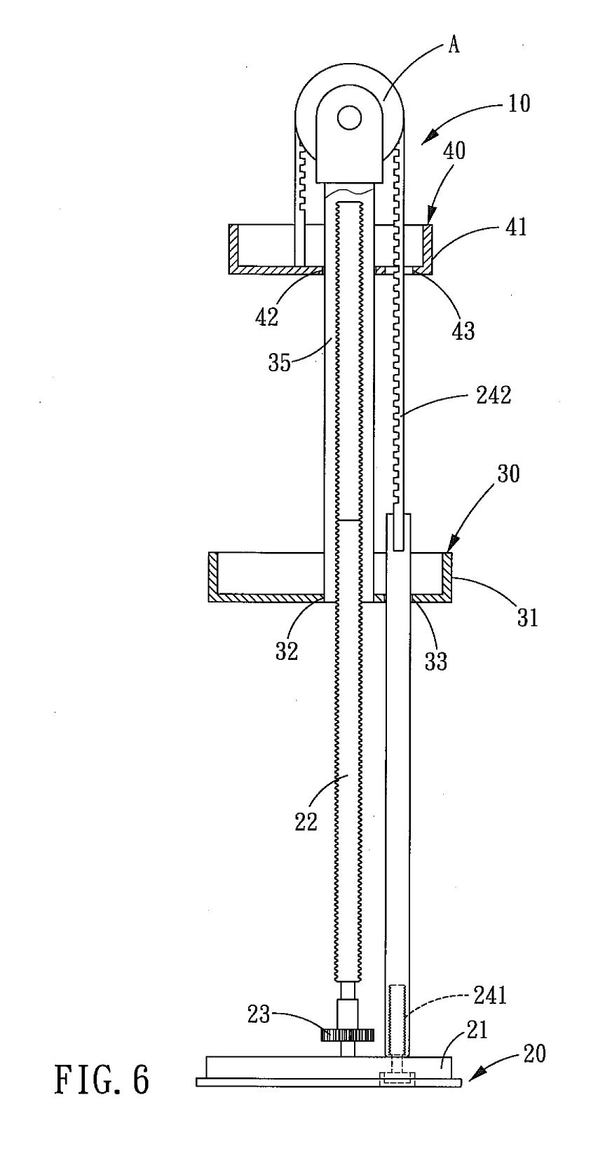

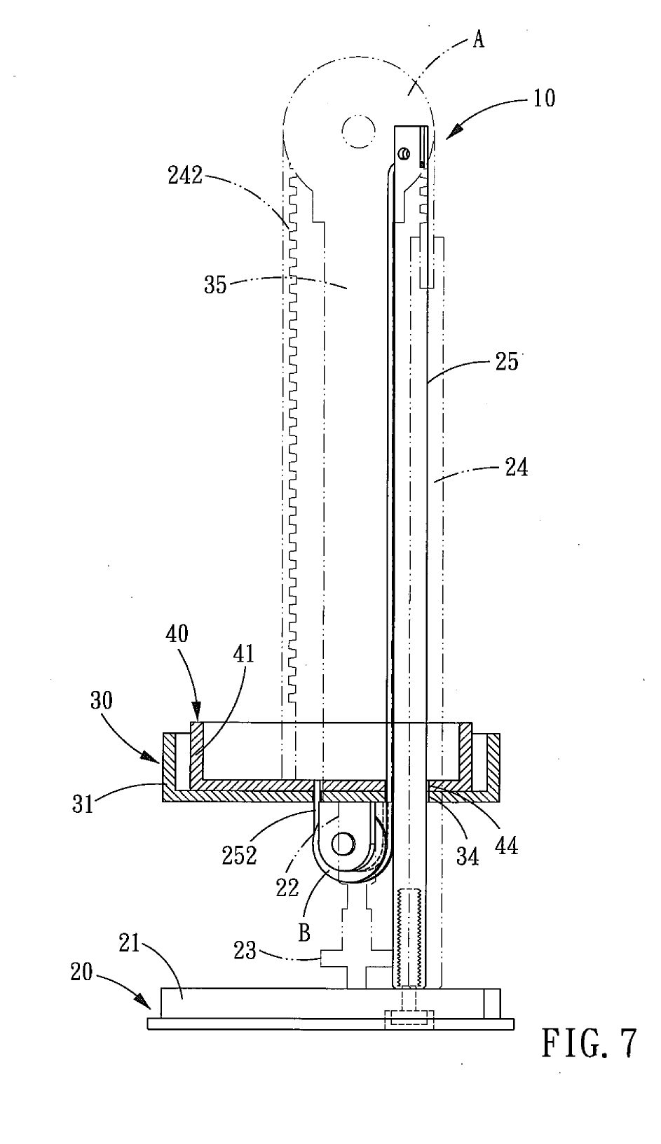

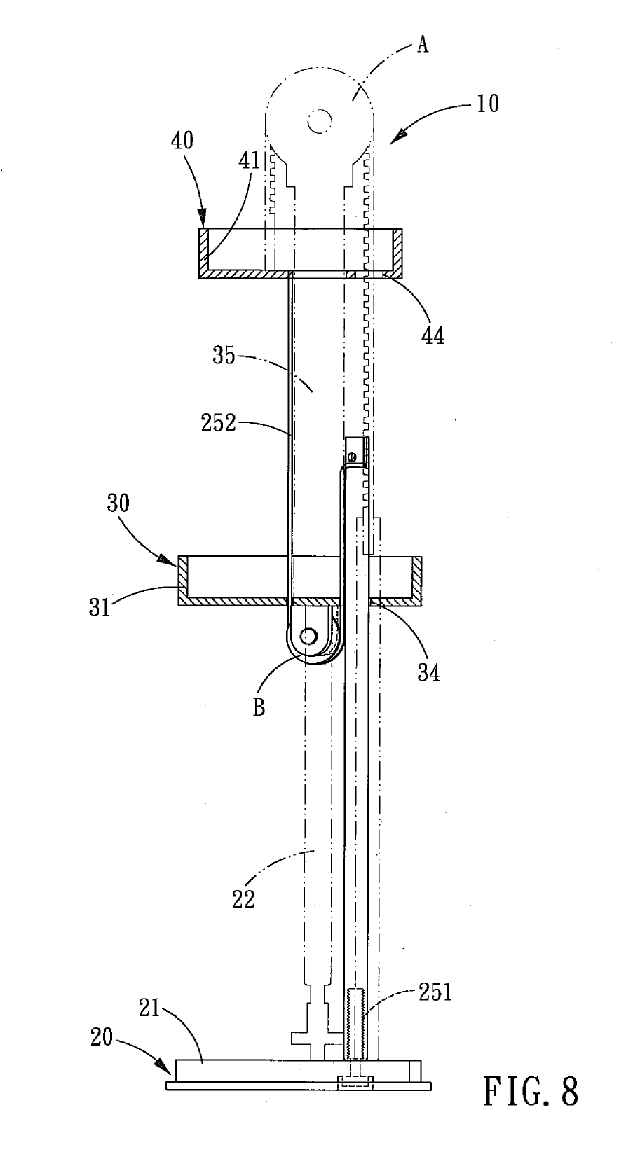

Referring to FIGS. 4-8, a linear actuator 10 in accordance with the present invention comprises an outer pipe 20, a middle pipe 30 and an inner pipe 40.

The outer pipe 20 has an approximately triangle-shaped cross section. A periphery of the outer pipe 20 is formed with three spaced-apart arc-shaped portions 201 and three guiding portions 202 that are alternatively arranged in such a manner that one arc-shaped portion 201 is located between two guiding portions 202, or one guiding portion 202 is located between two arc-shaped portions 201. The outer pipe 20 is a penetrated hollow member. One end of the outer pipe 20 is disposed with a cover 21, and a screw 22 is axially and pivotally disposed on the cover 21. One end of the screw 22 is radially formed with a gear 23, and the gear 23 is dynamically connected to a motor by a belt. A first positioning rod 24 and a second positioning rod 25 are axially locked to the cover 21 by a first adjustment screw 241 and a second adjustment screw 251, respectively. The screw 22, the first positioning rod 24 and the second positioning rod 25 are parallel to and spaced-apart from one another. A top end of the first positioning rod 24 is fixed with a first pulling member 242 that is a belt. A top end of the second positioning rod 25 is fixed with a second pulling member 252 that is a steel rope.

The cross section area of the middle pipe 30 is smaller than that of the outer pipe 20. A periphery of the middle pipe 30 is formed with three spaced-apart arc-shaped portions 301 and three guiding portions 302 that are alternatively arranged. The middle pipe 30 is pivotally disposed in the outer pipe 20, and the arc-shaped portions 301 and the guiding portions 302 of the middle pipe 30 are located correspondingly to the arc-shaped portions 201 and the guiding portions 202 of the outer pipe 20. The middle pipe 30 is a penetrated hollow member. One end of the middle pipe 30 is disposed with a cover 31. A first through hole 32, a second through hole 33 and a third through hole 34 are defined in the cover 31. The first through hole 32, the second through hole 33 and the third through hole 34 are parallel to and spaced-apart from one another. One side of the first through hole 32 is axially formed with a pushing post 35 having a hole 351 for threading with the screw 22 of the outer pipe 20. A first guiding wheel A is pivotally disposed at a top end of the pushing post 35. The second through hole 33 is provided for insertion of the first positioning rod 24 of the outer pipe 20, and the third through hole 34 is provided for insertion of the second positioning rod 25 of the outer pipe 20. A lower side of the cover 31 is axially and pivotally disposed with a second guiding wheel B that is received in the outer pipe 20.

The cross section area of the inner pipe 40 is smaller than that of the middle pipe 30. A periphery of the inner pipe 40 is formed with three spaced-apart arc-shaped portions 401 and three guiding portions 402 that are alternatively arranged. The inner pipe 40 is pivotally disposed in the middle pipe 30, and the arc-shaped portions 401 and the guiding portions 402 of the inner pipe 40 are located correspondingly to the arc-shaped portions 301 and the guiding portions 302 of the middle pipe 30. The inner pipe 40 is a penetrated hollow member. One end of the inner pipe 40 is disposed with a cover 41, and a first through hole 42, a second through hole 43 and a third through hole 44 are defined in the cover 41 and are located correspondingly to the pushing post 35, the second through hole 33 and the third through hole 34 of the cover 31 of the middle pipe 30, respectively. The first through hole 42 is provided for insertion of the pushing post 35 of the middle pipe 30, such that the first guiding wheel A of the pushing post 35 is received in the inner pipe 40. The second through hole 43 is provided for insertion of the first positioning rod 24 of the outer pipe 20. One end of the first pulling member 242 is fixed to the first positioning rod 24, and the other end of the first pulling member 242 is fixed to a top side of the cover 41 of the inner pipe 40. And the first pulling member 242 is rolled around the first guiding wheel A. The third through hole 44 is provided for insertion of the second positioning rod 25 of the outer pipe 20. One end of the second pulling member 252 is fixed to the second positioning rod 25, and the other end of the second pulling member 252 is fixed to a lower side of the cover 41 of the inner pipe 40. And the second pulling member 252 is rolled around the second guiding wheel B.

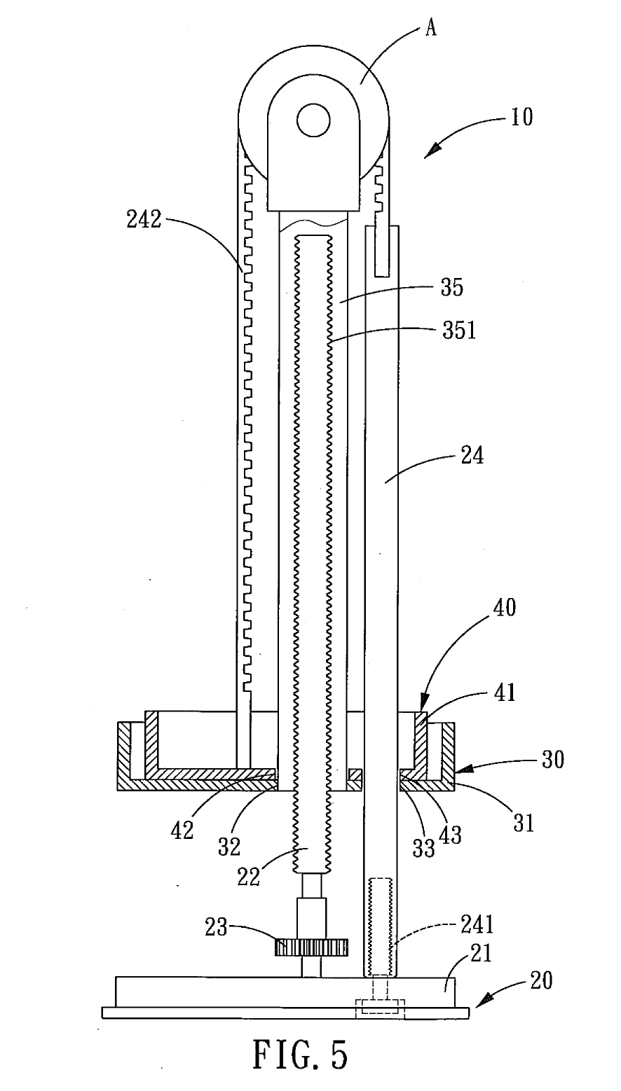

For a better understanding of the present invention, its operations and functions, reference should be made to FIGS. 5-8 again:

The outer threads of the screw 22 are threaded with the inner threads of the hole 351, the screw 22 rotates along the hole 351, so as to drive the pushing post 35 to move, thus making the arc-shaped portions 301 and the guiding portions 302 of the middle pipe 30 move upward along the arc-shaped portions 201 and the guiding portions 202 of the outer pipe 20. Meanwhile, the first guiding wheel A of the pushing post 35 rolls along the first pulling member 242. Since one end of the first pulling member 242 is fixed by the first positioning rod 24, the other end of the first pulling member 242 will pull the cover 41 of the inner pipe 40 to move, such that the arc-shaped portions 401 and the guiding portions 402 of the inner pipe 40 will move upward along the arc-shaped portions 301 and the guiding portions 302 of the middle pipe 30. At the same time, the inner pipe 40 will pull one end of the second pulling member 252 to move, and since the other end of the second pulling member 252 is fixed by the second positioning rod 25, the second guiding wheel B will roll along the second pulling member 252, so as to facilitate the middle pipe 30 to move.

To summarize, the linear actuator of the present invention orderly comprises an inner pipe, a middle pipe and an outer pipe, and the pipes are pivotally connected with each other. Each pipe is formed with at least three arc-shaped portions and three guiding portions, and the pipes abut against each other. The outer pipe is axially formed with a screw and two positioning rods that are passed through the middle pipe and the inner pipe, respectively. One end of each positioning rod is fixed with a pulling member, and one end of each pulling member is fixed to the inner pipe. The middle pipe is axially formed with a pushing post threaded with the screw. The pushing post and the middle pipe are pivotally disposed with a guiding wheel for rolling the pulling members, respectively. The pipes can be moved by the relative motion of the screw and the pushing post by cooperating with the guiding wheels and the pulling members, such that the pipes can be extended or retracted synchronously.

While we have shown and described various embodiments in accordance with the present invention, it should be clear to those skilled in the art that further embodiments may be made without departing from the scope of the present invention.

What is claimed is:

1. A linear actuator, comprising:
an outer pipe being annularly formed with a plurality of spaced-apart arc-shaped portions and guiding portions, one end of the outer pipe being disposed with a cover, the cover being axially disposed with a screw, a first positioning rod and a second positioning rod, one end of the first positioning rod and the second positioning rod being disposed with a first pulling member and a second pulling member, respectively;
a middle pipe being pivotally disposed in the outer pipe and annularly formed with a plurality of spaced-apart arc-shaped portions and guiding portions, the arc-shaped portions and the guiding portions of the middle pipe being abutted against the arc-shaped portions and the guiding portions of the outer pipe, one end of the middle pipe being disposed with a cover located correspondingly to the cover of the outer pipe, one side of the cover of the middle pipe being formed with a pushing post having a hole and threading with the screw of the outer pipe, a guiding wheel being pivotally disposed on the pushing post, the cover of the middle pipe being defined with a plurality of through holes for insertion of the first and second positioning rods of the outer pipe, the other side of the cover of the middle pipe being pivotally disposed with a guiding wheel;
an inner pipe being pivotally disposed in the middle pipe and annularly formed with a plurality of spaced-apart arc-shaped portions and guiding portions, the arc-shaped portions and the guiding portions of the inner pipe being abutted against the arc-shaped portions and the guiding portions of the outer pipe, one end of the inner pipe being disposed with a cover located correspondingly to the cover of the middle pipe, the cover of the inner pipe being defined with a plurality of through holes corresponding to the pushing post and the through holes of the cover of the middle pipe, one of the through holes of the cover of the inner pipe being provided for insertion of the pushing post of the middle pipe, one of the through holes of the cover of the inner pipe being provided for insertion of the first positioning rod of the outer pipe, one end of the first pulling member being fixed to the first positioning rod of the outer pipe, the other end of the first pulling member being assembled to the cover of the inner pipe, the first pulling member being rolled around one of the guiding wheels, one of the through holes of the cover of the inner pipe being provided for insertion of the second positioning rod of the outer pipe, one end of the second pulling member being fixed to the second positioning rod of the outer pipe, the other end of the second pulling member being assembled to the cover of the inner pipe, and the second pulling member being rolled around the other guiding wheel.

2. The linear actuator as claimed in claim 1, wherein each of the positioning rods of the cover of the outer pipe is locked to the cover of the outer pipe by an adjustment screw.

3. The linear actuator as claimed in claim 1, wherein the pulling members of the outer pipe are belts.

4. The linear actuator as claimed in claim 1, wherein the pulling members of the outer pipe are steel ropes.

5. The linear actuator as claimed in claim 1, wherein the arc-shaped portions and the guiding portions of the outer pipe are spaced-apart from one another, the arc-shaped portions and the guiding portions of the middle pipe are spaced-apart from one another, and the arc-shaped portions and the guiding portions of the inner pipe are spaced-apart from one another.
